(19) United States
(12) Patent Application Publication
(10) Pub. No.: US 2007/0245392 A1
(43) Pub. Date: Oct. 18, 2007

(54) Disaster recovery

(75) Inventor: Sudy Shen, Richmond Hill (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/731,925

(22) Filed: Apr. 2, 2007

Related U.S. Application Data
(60) Provisional application No. 60/788,280, filed on Mar. 31, 2006.

(51) Int. Cl. H04N 7/173; H04N 7/16

(52) U.S. Cl. 725/115; 725/92; 725/145

(57) ABSTRACT

A system for recovery of the broadcast facility is disclosed. The broadcast facility includes a module containing scheduling information, a video server containing program content, and a transmitter. A replicator is coupled to the module and the video server. The replicator monitors the scheduling information. A playout device is at a location remote from the broadcast facility. The playout device is coupled to the replicator. The playout device receives updated copies of scheduled program content while the broadcast facility remains operational. The playout device also contains recovery program content including the updated copies of the program content and other content. The playout device is also coupled to a remote transmitter. The video server provides program content for broadcast unless there is a failure at the broadcast facility. At this time, the remote transmitter begins transmitting recovery content from the playout device.

### CROSS REFERENCE TO RELATED APPLICATIONS

This application claims the benefit of U.S. Provisional Application No. 60/788,280, filed Mar. 31, 2006.

### BACKGROUND

The present disclosure is directed to broadcast television facilities. More particularly, the present disclosure is directed to a system and method for providing reliable and cost effective disaster recovery for a broadcast television facility in the event of a failure within the facility that leads to a disruption of the transmission of the broadcast signal.

FIG. 1 shows a main broadcast facility 10 of the prior art illustrated schematically. FIG. 1 is greatly simplified and only those components dealing with the distribution or broadcasting of programming content over a transmitter 19 are shown. Other components typically found in a broadcast facility such as production, post-production, recording, newsroom and the like have been omitted for clarity. The distribution of content is controlled by a station automation module 12 which controls the operation of a group of video servers 8 which contain digitized copies of television programming. Video servers store only a limited amount of programming material and content is regularly being deleted from or added to the video servers according to the requirements of the broadcasting schedule. A much larger amount of program content is stored in a digital tape library 16 which is controlled by an archive manager 14 that cooperates with the station automation module and supplies content from the digital tape libraries to the video servers when needed. A programming schedule managed by the station automation module controls when the content stored in a video server is sent to a transmitter for distribution to a group of viewers.

Employing multiple video servers within the broadcasting facility provides some redundancy and protection against the risk of one of them failing. One video server for example VS 3 in FIG. 1 could act as a back-up server containing duplicate copies of programming content in case a primary video server for example VS 1 or VS 2 fails. In such a situation, station automation module 2 would simply direct VS 3 to transmit content for distribution to the transmitter. This back-up capability is limited in extent however because of the relatively small amount of programming material that can be economically stored on a video server, and because it is limited to only those situations where a video server is the component which fails. A larger system failure within the broadcast facility or a regional systemic failure such as a loss of electricity for an extended period of time requires additional back-up means to continue providing broadcast programming without interruption. In addition to providing a larger scope of back-up protection, it is desirable to have a back-up method and system that does not require additional staff and is non-intrusive and easily integrated into the current broadcast facility system.

### SUMMARY

This disclosure relates to a system for providing recovery for a broadcast television facility in the event of failure that leads to a disruption of the transmission of programming. The disclosed examples include several advantages over the prior art facility of FIG. 1. For example, the disclosed examples provide a system for providing reliable and cost effective disaster recovery of the broadcast facility of the prior art.

In one aspect, the disclosure relates to a system suitable for recovery of the broadcast facility, where the broadcast facility includes a module containing scheduling information, at least one video server containing program content, and a transmitter coupled to the at least one video server for broadcasting program content.

In this aspect, the system includes a replicator and playout device. The replicator is coupled to the module and the at least one video server. The replicator monitors the scheduling information contained in the module. The playout device is at a location remote from the broadcast facility. The playout device is coupled to the replicator by way of a data transmission link. The playout device receives updated copies of scheduled program content while the broadcast facility remains operational. The playout device also contains recovery program content including the updated copies of the program content and other content. The playout device is also coupled to a remote transmitter at a location remote from the broadcast facility. The video server provides program content to the transmitter for broadcast unless there is a failure at the broadcast facility interrupting transmission of the program at which time the remote transmitter begins transmitting recovery content from the playout device.

In another aspect, the disclosure relates to another system suitable for recovery of the broadcast facility. The broadcast facility includes a module containing a playlist and also includes at least one video server containing program content including program items.

This system also includes a replicator and a playout device. The replicator is coupled to the module and at least one video server of the broadcast facility. The replicator has a replicator storage medium containing a copylist, and it has a content manager operably coupled to the storage medium. The playout device is located at a location remote from the broadcast facility. The playout device is coupled to the replicator and includes a first storage medium containing a remote playlist and a content storage medium operably coupled to the first storage medium. The content manager of the replicator causes the video server to copy program items from the program content to the content storage medium on the playout device. The content manager also maintains a list of the program items copied to the playout device in the copylist. The remote playlist contains a copy of the playlist and the copylist and includes an identifier of whether the copy of the program items in the copylist is stored in the content storage medium in the playout device as replicated content.

### BRIEF DESCRIPTION OF THE DRAWINGS

FIG. 1 is a schematic block diagram of a broadcast facility of the prior art.

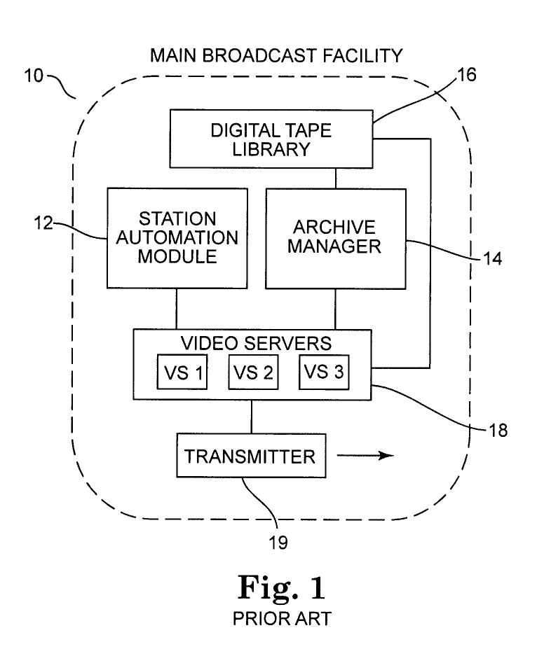

FIG. 2 is a schematic block diagram of an example system of the present disclosure.

FIG. 3 is a schematic block diagram of another example system of the present disclosure, which can be a more detailed example of the system of FIG. 2.

FIG. 4 is a flowchart of an example process suitable for the systems of FIGS. 2 and 3.

FIG. 5 is a flowchart of another example process suitable for the systems of FIGS. 2 and 3.

### DESCRIPTION

This disclosure relates to a system for providing recovery for a broadcast television facility in the event of failure that leads to a disruption of the transmission of programming. The disclosure, including the figures, describes the system with reference to several illustrative examples. Other examples are contemplated and are mentioned below or are otherwise imaginable to someone skilled in the art. For example, the term television should not be construed to mean only analog or digital broadcasts through typical transmissions such as off-air, cable, and satellite. Rather, the term television can include any transmittable video including video available from websites, Internet protocol television (IPTV), and others. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

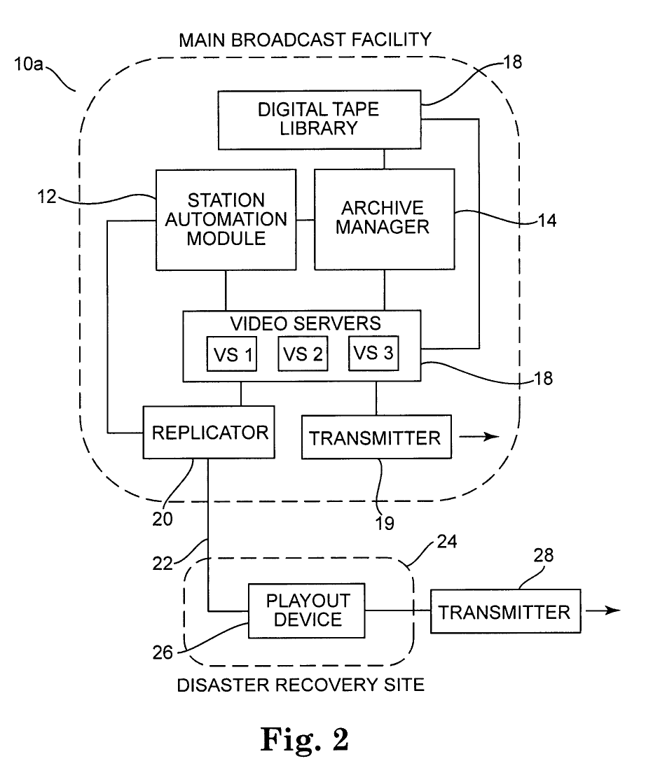

FIG. 2 illustrates schematically a broadcast facility that is equipped with additional components which provide back-up or disaster recovery for the entire broadcast system. Replicator 20 is connected to both the station automation module 2 and video servers 8 through a computer network and is also connected to a remote disaster recovery site 24 by a data transmission link 22. Link 22 is preferably a high speed Internet connection such as cable or DSL or the like. A playout device 26 is within the disaster recovery site 24 and is connected to a second remote transmitter 28. Replicator 20 continuously monitors current and future scheduling information generated by station automation module 12 and sends copies of scheduled programming content via link 22 to the disaster recovery site 24 where it is stored on playout device 26. In the event that the main broadcast facility cannot transmit programming content over its local transmitter 10, playout device 26 will be activated to transmit copies of the programming content over the remote transmitter 28.

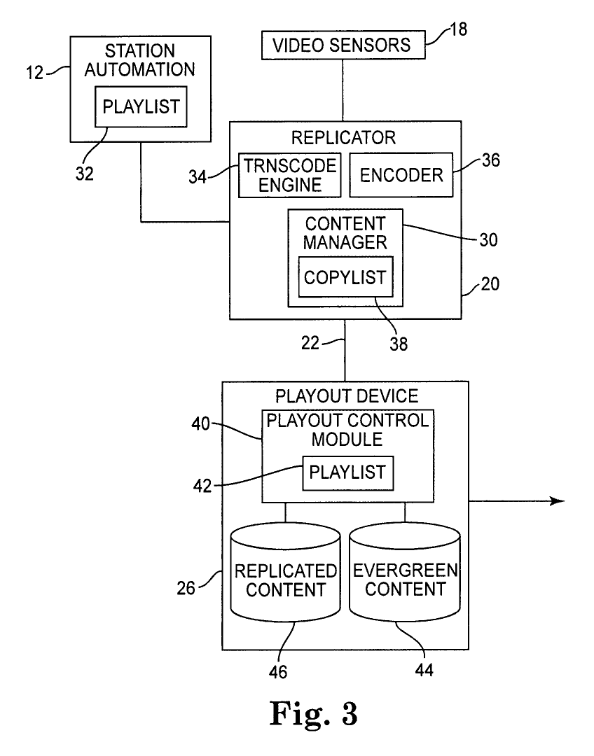

FIG. 3 reveals the portions of the system including the replicator 20 and playout device 26 in more detail. Replicator 20 contains a content manager 30 which communicates with station automation module 12, video servers 18 and playout device 26. The content manager continuously monitors a playlist 32 stored in station automation module 12 and searches for instances of the programming content listed in the playlist on the group of video servers 18. If the content is found on a video server the content manager imports a copy of it for subsequent transfer to the playout device 26 at the remote disaster recovery site. A copylist 38 is maintained by content manager 30 of all material that has been copied to the playout device. Because a number of different video servers each having unique data storage formats may be employed by the broadcast facility, the replicator 20 contains a transcode engine 34 which is capable of transcoding the content stored on the video servers into a standard format for subsequent processing and transmission. Replicator 20 also contains an encoder 36 for encoding programming content into a compressed format for more efficient transmission over data link 22. A suitable low bit-rate format which allows a lower bandwidth connection to the remote disaster recovery site is Windows Media (WM9) from MicroSoft Corp.

Playout device 26 contains a playout control module 40 which receives the programming content from the replicator 20 and stores it on a suitable storage device 46, such as a computer hard drive or group of hard drives. The playout control module 40 manager contains a remote playlist 42 that corresponds to the playlist 32 stored in the station automation module 12. The playout control module 40 also incorporates information from the copylist 38 maintained by the replicator that indicates if the material scheduled to be played has in fact been received from the replicator and is stored on storage device 46.

In some situations it is possible that the content required for broadcasting may not have been transmitted to playout device 26 in time to meet the broadcast schedule. To adapt to such situations playout device 26 contains a store of evergreen content 44 that can be substituted for the missing programming content. Evergreen content is material that has no restrictions based on material age or time of day playout. Examples of evergreen material include station identification, public service announcements, short promotions or generic programming content. Evergreen metadata is stored with the evergreen content and includes the length (playing time) of the evergreen content and its playout count, which is a record of how long it's been since the evergreen content was last broadcast. The evergreen metadata is used to automatically determine the programming sequence of evergreen content substitution when needed. In a preferred embodiment, the selection of evergreen content is governed by applying evergreen metadata to the following rules:

1. Substitute the longest evergreen clip that is shorter than the missing playlist content. If there are multiple candidate evergreen clips of equal length, use the evergreen content that has not been aired for the longest time (least recently, or longest playout count).

2. Substitute the longest evergreen clip that is shorter than or equal to the now empty space with the largest playout count.

3. Continue substitution with shorter and shorter evergreen clips until it is no longer possible to substitute without clipping off the end of the clip. In this and only this case, cut the clip short as necessary.

Once initiated, the playout device will sequentially play the stored replicated content, substituting evergreen material automatically when needed, until completed. The playlist can be manually or automatically appended to during play-out, or a new playlist opened after completion of a previous playlist to provide unlimited disaster recovery broadcasting.

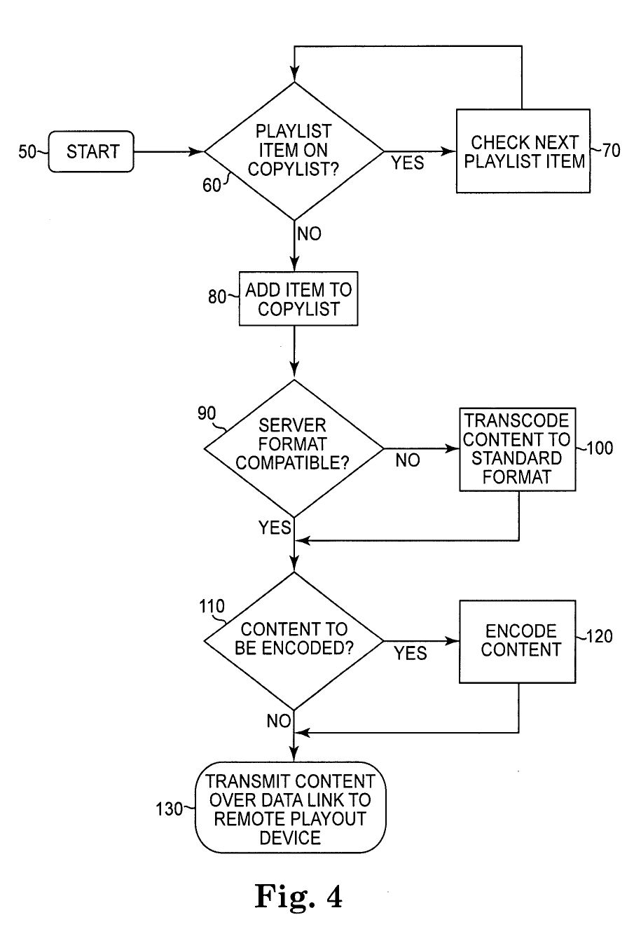

FIG. 4 is a flowchart that illustrates the process of replicating content found on video servers 18 and transmitting it to a remote disaster recovery playout device 26. The process starts within content manger 30 within replicator 20 indicated in FIGS. 2 and 3. The content manager compares a current playlist item with its copylist at step 60 to see if the content has been previously replicated and transmitted. If the item has been replicated, the next item in the playlist is compared and so on until the entire current playlist has been compared with the copylist. If the playlist item has not been replicated, the content manager adds the item to the copylist at step 80 and proceeds to step 90 that determines if the format of the item as stored on its data server is compatible with the playout device. If the format is not compatible, it is transcoded at step 100 by transcode engine 34. Step 110 in the replicating process determines if the content is to be encoded or not prior to transmission, and if it is, it is encoded at step 120. Finally at step 130 the playlist item is transmitted over data link 22 to the remote disaster recovery playout device 26.

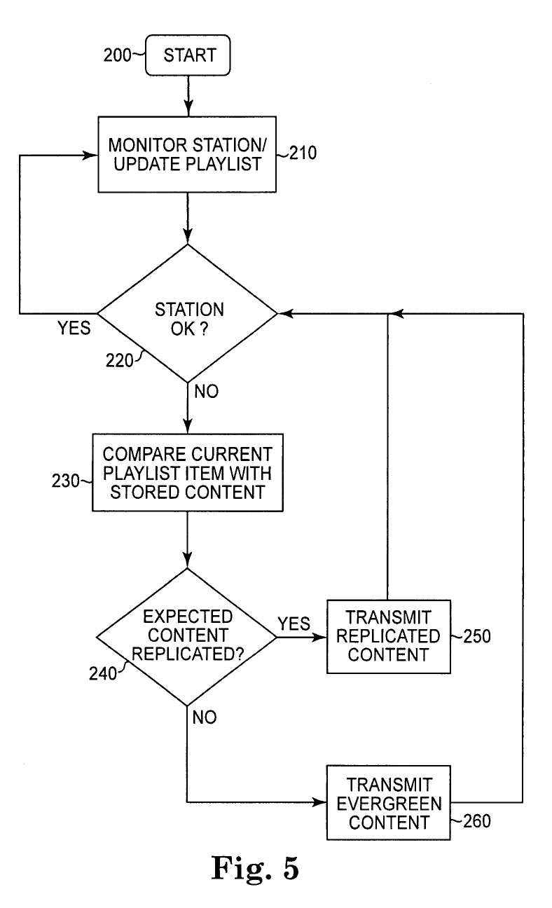

FIG. 5 is a flowchart that illustrates the operation of the playout device 26. The normal operational mode of playout device 26 is indicated at step 210 and involves monitoring the status of the main broadcast facility, maintaining an up to date copy of playlist 32, and receiving replicated content from replicator 20. Step 220 determines the functional status of the main broadcast facility and if a failure is detected, the playout device proceeds into a disaster recovery mode. Step 230 in the disaster recovery process determines if the current expected playlist item has been replicated and is stored locally within the playout device. If it is, the playout device will send the required content to transmitter 28 for broadcasting. If the required item has not yet been replicated, the playout device will substitute evergreen content for a duration equal to the duration of the expected, but not replicated current play list item. After successful transmission of either the replicated or substituted evergreen content, the disaster recovery process will return to step 220 to determine if continued disaster recovery playout of content is warranted.

Although the above example of a disaster recovery mode is limited to the transmission of a single playout item (or evergreen content) at a time followed by a functional check of the main broadcast facility's status, this need not be the case. Other playout routines are possible. For example the playout device could dynamically compile a local playlist combining locally stored replicated content interspersed with evergreen content where needed and play the entire list of items before returning to step 220 for a status check. In addition, a local play list could be compiled and executed manually by a person at the remote site, or elsewhere through a functioning communication link.

The inventive disaster recovery system and method provides an automatic, low-cost, non-intrusive and adaptive method of providing disaster recovery broadcasting services in the event of a significant failure within a main broadcast facility.

What is claimed is:

1. A system suitable for recovery of a broadcast facility including a module containing scheduling information, at least one video server containing program content, and a transmitter coupled to the at least one video server for broadcasting program content, the system comprising:
a replicator operably coupled to the module and the at least one video server, wherein the replicator monitors the scheduling information contained in the module; and
a playout device at a location remote from the broadcast facility, the playout device operably coupled to the replicator by way of a data transmission link such that the playout device receives updated copies of scheduled program content while the broadcast facility remains operational, the playout device containing recovery program content including the updated copies of the program content and other content, wherein the playout device is operably coupled to a remote transmitter at a location remote from the broadcast facility;
wherein the at least one video server provides program content to the transmitter for broadcast unless there is a failure at the broadcast facility interrupting transmission of the program at which time the remote transmitter begins transmitting recovery content from the playout device.

2. The system of claim 1 wherein the replicator is located at the broadcast facility.

3. The system of claim 2 wherein the replicator is coupled to the module and the at least on video server through computer network.

4. The system of claim 1 wherein the replicator continuously monitors the scheduling information contained in the module.

5. The system of claim 1 wherein the replicator is operably coupled to a plurality of video servers wherein at least one of the plurality of video servers contains backup information related to the content on other of the plurality of video servers.

6. The system of claim 1 wherein the replicator is connected to the playout device through an Internet connection.

7. The system of claim 1 wherein the playout device stores the scheduled program content in a storage device.

8. The system of claim 7 wherein the memory device is at least one computer hard disk drive.

9. A system suitable for recovery of a broadcast facility including a module containing a playlist and including at least one video server containing program content including program items, the system comprising:
a replicator having a replicator storage medium containing a copylist and having a content manager operably coupled to the storage medium, the replicator operably coupled to the module and the at least one video server; and
a playout device at a location remote from the broadcast facility, the playout device operably coupled to the replicator, the playout device including a first storage medium containing a remote playlist, and a content storage medium operably coupled to the first storage medium;
wherein the content manager of the replicator causes the at least one video server to copy program items from the program content to the content storage medium on the playout device, and wherein the content manager maintains a list of the program items copied to the playout device in the copylist;
wherein the remote playlist contains a copy of the playlist and the copylist and includes an identifier of whether the copy of the program items in the copylist is stored in the content storage medium in the playout device as replicated content.

10. The system of claim 9 wherein the replicator is located at the broadcast facility.

11. The system of claim 10 wherein the replicator is coupled to the module and the at least on video server through computer network.

12. The system of claim 9 wherein the replicator continuously monitors the playlist contained in the module.

13. The system of claim 9 wherein the replicator further includes a transcode engine operably coupled to the video server, wherein the transcode engine transcodes at least some of the program items into a standard format.

14. The system of claim 9 wherein the replicator further includes an encoder operably coupled to the program items, wherein the encoder encodes the program items into a compressed format for transmission to the playout device.

15. The system of claim 14 wherein the compressed format low bit-rate format for a lower bandwidth connection to the playout device.

16. The system of claim 9 wherein the content storage medium in the playout device further include evergreen content items, wherein evergreen content items are broadcast if the program content item scheduled to be broadcast is not available as replicated content.

17. The system of claim 16 wherein the evergreen content items includes station identification, public service announcements, and short promotions.

18. The system of claim 16 wherein the playout device maintains evergreen metadata stored with each evergreen content item wherein the evergreen metadata includes information on the length of time of the evergreen content items and the length of time since the evergreen content item was last broadcast.

19. The system of claim 18 wherein the selection of evergreen content items for broadcast is governed by applying the evergreen metadata to rules.

20. A system suitable for recovery of a broadcast facility including a module containing a playlist and including at least one video server containing program content, the system comprising:
means for monitoring the playlist for program content on the at least one video server and causing the video server to copy new program content and broadcast schedules to a remote facility; and
means for playing out copied programs from the remote facility as scheduled by the broadcast facility when the broadcast facility is not operational and for playing out evergreen content form the remote facility when the broadcast facility is not operation and scheduled copied programs are not available.
